(19) United States
(12) Patent Application Publication
(10) Pub. No.: US 2022/0272166 A1
(43) Pub. Date: Aug. 25, 2022

(54) Method, Apparatus, and System for Implementing Service Function Deployment

(71) Applicant: Huawei Technologies Co., Ltd., Shenzhen (CN)

(72) Inventors: Hao Wu, Nanjing (CN); Chuntao Wang, Nanjing (CN); Kai Lu, Shenzhen (CN); Jianbing Wang, Nanjing (CN)

(21) Appl. No.: 17/740,912

(22) Filed: May 10, 2022

Related U.S. Application Data
(63) Continuation of application No. PCT/CN2020/116490, filed on Sep. 21, 2020.

(30) Foreign Application Priority Data
Nov. 11, 2019 (CN) 201911096526.3

(51) Int. Cl. H04L 67/51; G06N 5/04

(52) U.S. Cl. CPC H04L 67/51; G06N 5/04

(57) ABSTRACT

A system for implementing service function deployment includes an active apparatus and a standby apparatus for a first service, such as an active main processing unit (MPU) and a standby MPU. The active apparatus is configured to process the first service and deploy a first function module (such as a feature extraction module or an inference module) for a second service (such as an artificial intelligence (AI) service) on the standby apparatus. The standby apparatus is configured to process data of the second service by using the first function module. The second service may be implemented by using an idle resource of the standby apparatus for the first service.

### CROSS-REFERENCE TO RELATED APPLICATIONS

This is a continuation of International Patent Application No. PCT/CN2020/116490 filed on Sep. 21, 2020, which claims priority to Chinese Patent Application No. 201911096526.3 filed on Nov. 11, 2019. The disclosures of the aforementioned applications are hereby incorporated by reference in their entireties.

### TECHNICAL FIELD

Embodiments of the present disclosure relate to the fields of communications technologies and artificial intelligence (AI), and in particular, to a method, an apparatus, and a system for implementing service function deployment.

### BACKGROUND

To enhance reliability of implementing a network service in a communications system, an active/standby working manner is usually used. One of a plurality of apparatuses in the communications system serves as an active apparatus for the network service, and one or more other apparatuses serve as a standby apparatus for the network service. For example, when a firewall service is implemented by using a device cluster, one device in the device cluster serves as an active device for the firewall service, and one or more other devices serve as a standby device for the firewall service. For another example, when a network service such as protocol processing, route calculation, security authentication, or user access is implemented by using a network device including a plurality of main processing units (MPUs), one of the MPUs serves as an active MPU for the network service, and one or more other MPUs serve as a standby MPU for the network service.

Applying data processing services such as an AI service to a network has become a popular development direction in the field of communications technologies. When a data processing service is implemented by using a communications system working in an active/standby manner, the data processing service is usually implemented by using an active apparatus in the communications system.

The data processing service usually involves storage and statistical analysis of a large amount of data, and requires a large amount of computing resources and storage resources. In this manner, the data processing service is implemented with relatively low efficiency.

### SUMMARY

Embodiments of the present disclosure provide a method, an apparatus, and a system for implementing service function deployment, to resolve a problem of relatively low efficiency of implementing a data processing service by using a communications system working in an active/standby manner.

According to a first aspect, a system for implementing service function deployment is provided. The system includes an active apparatus and a standby apparatus for a first service. The active apparatus is configured to process the first service and deploy a first function module for a second service on the standby apparatus. The standby apparatus is configured to process data of the second service by using the first function module.

According to an implementation of the first aspect, the second service may be implemented by using an idle resource of the standby apparatus for the first service, to effectively ensure efficiency of implementing the second service. In addition, contention with the first service for a resource of the active apparatus may be avoided, thereby ensuring efficiency of implementing the first service by using the active apparatus.

The system may be a device cluster, the active apparatus is an active device in the device cluster, and the standby apparatus is a standby device in the device cluster. In this implementation, the second service can be efficiently implemented in the device cluster, and efficiency of implementing the first service by using the device cluster can also be ensured.

The system may be alternatively a network device including a plurality of MPUs. The network device works in an active/standby manner. The active apparatus is an active MPU, and the standby apparatus is a standby MPU. In this implementation, the second service can be efficiently implemented in the network device, and efficiency of implementing the first service by using the network device can also be ensured.

The second service may be an AI service. The AI service involves storage and processing of a large amount of data, and requires a relatively large amount of computing resources and storage resources. In this manner, efficiency of implementing the AI service can be effectively ensured.

The AI service includes a feature extraction module and an inference module, and usually further includes a data collection module and/or a result application module. The data collection module is configured to collect raw data required by the second service, and send the raw data to the feature extraction module. The feature extraction module is configured to extract a feature of the raw data to obtain feature data, and send the feature data to the inference module. The inference module is configured to draw an inference based on the feature data, and send an inference result to the result application module. The result application module applies the inference result.

The function modules for the AI service may be deployed in a plurality of manners. During specific implementation, the inference module may be deployed on the standby apparatus (such as a standby MPU). Because the inference module occupies a relatively large amount of computing resources, deploying the inference module on the standby MPU can use an idle resource of the standby MPU to ensure execution efficiency of the second service. If the second service further includes a training module independent of the inference module, because the training module also occupies a relatively large amount of computing resources, both the training module and the inference module may be deployed on the standby MPU.

Further, other function modules for the AI service may be deployed in the following manners.

In a deployment manner, the feature extraction module may also be deployed on the standby apparatus, to fully use the idle resource of the standby apparatus.

In another deployment manner, the feature extraction module may be deployed on an apparatus accommodating the data collection module. In this case, the apparatus accommodating the data collection module needs to transmit only the extracted feature data to the standby apparatus, without needing to transmit the raw data, thereby greatly reducing a communication bandwidth requirement between the apparatus and the standby apparatus.

In addition, the result application module may be deployed on the active apparatus or the standby apparatus. If the result application module needs to send the inference result or a processing result obtained by performing further processing based on the inference result to another entity, a location relationship between the other entity and the active apparatus or the standby apparatus may be referred to when a deployment location of the result application module is considered. For example, if the result application module needs to send the inference result or the processing result to another apparatus communicating with the active apparatus, or to another module (such as a module processing the first service) on the active apparatus, the result application module may be deployed on the active apparatus. If the result application module needs to send the inference result or the processing result to another apparatus communicating with the standby apparatus, the result application module may be deployed on the standby apparatus.

In a specific deployment manner, the result application module may be deployed on the active apparatus, and the result application module is further configured to send the inference result or the processing result to another apparatus communicating with the active apparatus, or to another module (such as a module processing the first service) on the active apparatus.

In another specific deployment manner, the result application module may be deployed on the standby apparatus, and the result application module is further configured to send the inference result or the processing result to another apparatus communicating with the standby apparatus.

In the foregoing implementation, the result application module and the other entity that needs the inference result or the processing result of the second service communicate with each other with relatively high efficiency.

According to a second aspect, an apparatus for implementing service function deployment is provided. The apparatus serves as an active apparatus for a first service and includes a deployment unit, a processing unit, and a communications unit. The processing unit is configured to process the first service. The deployment unit is configured to deploy a first function module for a second service on a standby apparatus for the first service by using the communications unit. The first function module is configured to process data of the second service.

The second service may be an AI service. Correspondingly, the first function module includes an inference module, and the inference module is configured to draw an inference based on feature data of the second service to obtain an inference result.

In an implementation, the first function module may further include a feature extraction module. The feature extraction module is configured to extract a feature of raw data of the second service to obtain the feature data. The inference module is configured to draw an inference based on the feature data obtained by the feature extraction module.

In another implementation, the deployment unit is further configured to deploy a feature extraction module for the second service on the active apparatus. The feature extraction module is configured to extract a feature of raw data of the second service to obtain the feature data. The communications unit is configured to send the feature data to the standby apparatus.

The deployment unit may be further configured to deploy a data collection module for the second service on the active apparatus. The data collection module is configured to collect the raw data of the second service.

The active apparatus may be an active MPU in a network device, the standby apparatus is a standby MPU in the network device, and the network device further includes a line processing unit (LPU). The deployment unit may be further configured to deploy a data collection module for the second service and a feature extraction module for the second service on the LPU. The data collection module is configured to collect raw data of the second service. The feature extraction module is configured to extract a feature of the data collected by the data collection module, to obtain feature data of the second service.

The second service may include a plurality of function modules. Correspondingly, the deployment unit may configure, according to a preset correspondence between an identifier of each function module for the second service and an apparatus identifier, each function module on an apparatus identified by a corresponding apparatus identifier; or may configure, according to a preset correspondence between a function module type and an apparatus identifier, each function module on an apparatus identified by an apparatus identifier corresponding to a function module type to which the function module belongs.

The deployment unit may be further configured to: when determining to start the second service, send a start instruction including each function module for the second service to an apparatus accommodating the function module. The start instruction is used to instruct the apparatus accommodating the function module to start the function module.

According to a third aspect, an apparatus for implementing service function deployment is provided. The apparatus serves as a standby apparatus for a first service and includes a deployment unit, a processing unit, and a communications unit. The communications unit is configured to receive a deployment instruction sent by an active apparatus for the first service. The deployment instruction is used to instruct the standby apparatus to deploy a first function module for a second service. The deployment unit is configured to deploy the first function module according to the deployment instruction. The first function module is configured to process data of the second service.

The second service may be an AI service. The first function module may include an inference module, and the inference module is configured to draw an inference based on feature data of the second service.

Correspondingly, the communications unit may be further configured to receive the feature data from the active apparatus. The inference module is configured to draw an inference based on the received feature data.

If a result application module for the second service is deployed on an active MPU, the communications unit may be further configured to send an inference result of the inference module to the active apparatus.

The first function module may further include the result application module, in other words, the result application module for the second service is deployed on the active apparatus. The result application module is configured to apply the inference result obtained by the inference module by drawing an inference.

During specific implementation, the active apparatus may be an active MPU in a network device, the standby apparatus is a standby MPU in the network device, and the network device further includes a line processing unit LPU. If a feature extraction module for the second service is deployed on the LPU, the communications unit may be further configured to receive the feature data from the LPU.

When the second service needs to be started, the communications unit is further configured to receive a start instruction from the active apparatus. The start instruction includes an identifier of the first function module. The deployment unit is further configured to start the first function module according to the start instruction.

According to a fourth aspect, a method for implementing service function deployment is provided. The method is performed by an active apparatus for a first service and includes: processing the first service; and deploying a first function module for a second service on a standby apparatus for the first service. The first function module is configured to process data of the second service.

The second service may include a plurality of function modules, and the active apparatus may deploy the plurality of function modules on corresponding apparatuses. The active apparatus may configure, according to a preset correspondence between an identifier of each function module for the second service and an apparatus identifier, each function module on an apparatus identified by a corresponding apparatus identifier; or may configure, according to a preset correspondence between a function module type and an apparatus identifier, each function module on an apparatus identified by an apparatus identifier corresponding to a function module type to which the function module belongs.

The active apparatus may be further configured to: when determining to start the second service, send a start instruction including each function module for the second service to an apparatus accommodating the function module. The start instruction is used to instruct the apparatus accommodating the function module to start the function module.

According to a fifth aspect, a method for implementing service function deployment is provided. The method is performed by a standby apparatus for a first service and includes: receiving a deployment instruction sent by an active apparatus for the first service, where the deployment instruction is used to instruct the standby apparatus to deploy a first function module for a second service; deploying the first function module according to the deployment instruction; and processing data of the second service by using the first function module.

The second service may be an AI service. The first function module includes an inference module, and the inference module is configured to draw an inference based on feature data of the second service.

Correspondingly, the method further includes: The standby apparatus receives the feature data from the active apparatus, and draws an inference by using the inference module based on the received feature data.

The standby apparatus may further send an inference result obtained by using the inference module to the active apparatus.

The first function module may further include a result application module, in other words, a result application module for the second service is deployed on a standby MPU. The method may further include: The standby apparatus applies, by using the result application module, the inference result obtained by the inference module by drawing an inference.

The active apparatus may be an active MPU in a network device, the standby apparatus is a standby MPU in the network device, and the network device further includes a line processing unit LPU. A feature extraction module for the second service may be deployed on the LPU. Correspondingly, the method may further include: receiving the feature data from the LPU.

During specific implementation, the standby apparatus may further receive a start instruction from the active apparatus, where the start instruction includes an identifier of the first function module; and start the first function module according to the start instruction.

According to a sixth aspect, an apparatus for implementing service function deployment is provided. The apparatus includes a processor and a communications interface. The communications interface is configured to communicate with another apparatus. The apparatus may serve as a standby apparatus for a first service. Correspondingly, the processor is configured to perform the method according to the fourth aspect. The apparatus may serve as an active apparatus for the first service. Correspondingly, the processor is configured to perform the method according to the fifth aspect.

According to a seventh aspect, a computer storage medium is provided. The computer storage medium stores instructions. When the instructions are executed by a processor, the method according to the fourth or fifth aspect is implemented.

Beneficial effects brought by the technical solutions provided in this disclosure include at least the following: The second service may be implemented by using an idle resource of the standby apparatus for the first service, to effectively ensure efficiency of implementing the second service. In addition, contention with the first service for a resource of the active apparatus may be avoided, thereby ensuring efficiency of implementing the first service by using the active apparatus.

### BRIEF DESCRIPTION OF DRAWINGS

To describe the technical solutions in the embodiments of the present disclosure more clearly, the following briefly describes the accompanying drawings required for the embodiments.

FIG. 1 is a schematic diagram of a networking structure of a communications system 100 according to an embodiment of the present disclosure;

FIG. 2 is a schematic diagram of a function module of an AI service according to an embodiment of the present disclosure;

FIG. 3 is another schematic diagram of a networking structure of a communications system 100 according to an embodiment of the present disclosure;

FIG. 4A to FIG. 4D, FIG. 5A, and FIG. 5B are schematic diagrams of a function module deployment manner according to an embodiment of the present disclosure;

FIG. 6A, FIG. 6B, and FIG. 6C are schematic flowcharts of a method 100 according to an embodiment of the present disclosure;

FIG. 7 is a schematic diagram of a deployment relationship between a function module and an apparatus according to an embodiment of the present disclosure;

FIG. 8 is a schematic diagram of a structure of an apparatus 200 according to an embodiment of the present disclosure; and

FIG. 9 is a schematic diagram of a structure of an apparatus 1000 according to an embodiment of the present disclosure.

### DESCRIPTION OF EMBODIMENTS

The following describes embodiments of the present disclosure with reference to accompanying drawings.

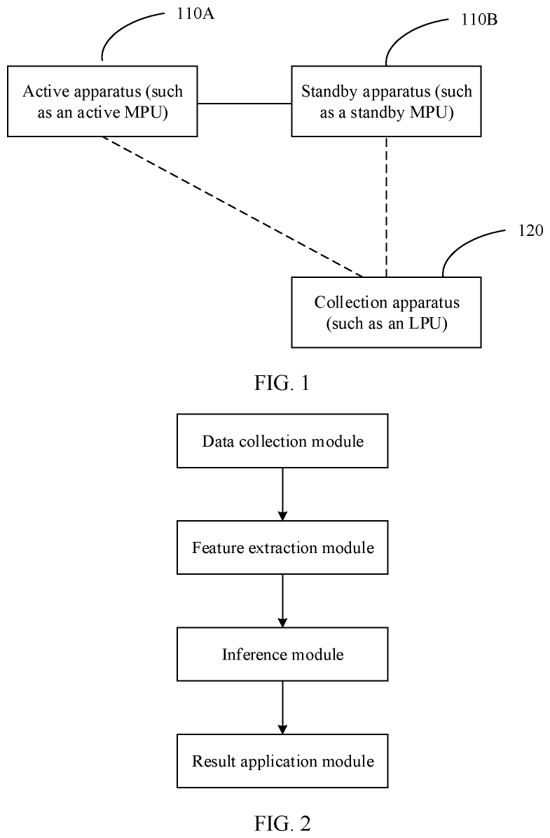

FIG. 1 is a schematic diagram of a networking structure of a communications system 100 according to an embodiment of the present disclosure. The communications system 100 includes at least two apparatuses 110. An apparatus 110A is an active apparatus for a first service and is configured to perform a function of the first service. An apparatus 110B is a standby apparatus for the first service. The first service may be a network service such as a firewall, protocol processing, route calculation, security authentication, or user access.

The communications system 100 may be further configured to perform a function of a second service. The second service may include only one function module, and the function module may be deployed on the standby apparatus 110B. The second service may alternatively include a plurality of function modules, and some or all of the function modules may be deployed on the standby apparatus 110B. During specific implementation, the active apparatus 110A may deploy some or all of the function modules for the second service on the standby apparatus 110B.

The second service is usually a data processing service, usually includes a data processing module, and may further include other function modules such as a data collection module and a result application module. The data collection module is configured to collect data (referred to as raw data) required by the second service, and send the raw data to the data processing module. The data processing module is configured to process the raw data, and send a processing result to the result application module. The result application module applies the processing result. The data processing module may be deployed on the standby apparatus 110B. If the data processing module includes a plurality of submodules, some submodules may be deployed on the standby apparatus 110B, and other submodules are deployed on another apparatus (such as the active apparatus 110A). The data collection module may be deployed on the active apparatus 110A, or may be deployed on an apparatus other than the apparatus 110, such as an apparatus 120 shown in FIG. 1 (referred to as a collection apparatus). The collection apparatus may be an apparatus in the communications system 100, or may be an apparatus outside the communications system 100. The result application module may be deployed on the active apparatus 110A or the standby apparatus 110B.

The second service may be an AI service, an access service, a security protection service, an operation and maintenance task, or the like.

The AI service may be AI-based application identification, AI-based key performance indicator (KPI) time series anomaly detection, or the like.

The access service may be used for user authentication, roaming identification, and the like. For this type of service, the data collection module is configured to collect information for service access processing, such as a mobile phone number of a user and a location of a user, and the data processing module is configured to process the collected data, for example, perform user authentication and roaming identification based on the collected data.

The security protection service may be central processing unit (CPU) attack defense packet preprocessing. For example, the first service running on the active apparatus is a CPU attack defense service. To perform the first service, a packet needs to be preprocessed, and packet preprocessing needs to occupy a large amount of computing resources and storage resources. Packet preprocessing may become an independent service, and some or all of function modules for the service are deployed on the standby apparatus for implementation. The standby apparatus returns a packet preprocessing result to the active apparatus, so that the active apparatus further performs the first service based on the packet preprocessing result. For this type of service, the data collection module is configured to collect a required packet, and the data processing module is configured to preprocess the packet.

The operation and maintenance service may be preventive maintenance data collection. For this type of service, the data collection module is configured to collect preventive maintenance data, and the data processing module is configured to preprocess, such as removing noise from, and save the collected preventive maintenance data.

When the second service is an AI service, the data processing module is usually divided into a feature extraction module and an inference module. With reference to FIG. 2, the following describes functions of each included function module when the second service is an AI service.

The data collection module is configured to collect raw data required by the second service, and send the raw data to the feature extraction module. For example, if the second service is KPI time series anomaly detection, the data required by the second service includes a KPI time series (such as a packet loss rate time series or a delay time series). It should be noted that, before sending the raw data to the feature extraction module, the data collection module may further preprocess the raw data, for example, remove noise from the raw data, and send preprocessed raw data to the feature extraction module.

The feature extraction module is configured to extract a feature of the raw data to obtain feature data, for example, a statistical feature, a fitting feature, and/or a frequency domain feature of each KPI time series, and send the feature data to the inference module.

The inference module is configured to draw an inference based on the feature data, for example, draw an inference about whether each KPI time series is abnormal, and send an inference result to the result application module. The inference module may draw an inference by using a pre-trained anomaly detection model.

The result application module applies the inference result, for example, displays the inference result, gives an alarm based on the inference result, and makes further detection based on the inference result (such as fault detection based on a KPI time series anomaly), or sends the inference result (such as to an apparatus other than the apparatus to which the result application module belongs, or to another module of the apparatus to which the result application module belongs).

The foregoing function modules have the following characteristics:

The data collection function needs to save a large amount of data, thereby occupying a relatively large amount of storage resources.

The feature extraction module needs to save or process a relatively large amount of data, thereby occupying a large amount of storage resources and computing resources.

The inference module needs to process a relatively large amount of data with a strict requirement for time, thereby occupying a large amount of computing resources (usually more than the feature extraction module).

The result application module usually needs to interact with another entity (such as another apparatus or another module located on the same apparatus), thereby occupying a relatively small amount of storage resources and computing resources.

In addition, the second service may further include a training function, to train an inference model (such as an anomaly detection model) used for drawing an inference. In this case, the training function may be implemented by using the inference module, or the training function may be implemented by using an independent training module. The training module also occupies a relatively large amount of computing resources.

The system 100 may be a device cluster, for example, a firewall cluster. The active apparatus 110A is an active device, and the standby apparatus 110B is a standby device.

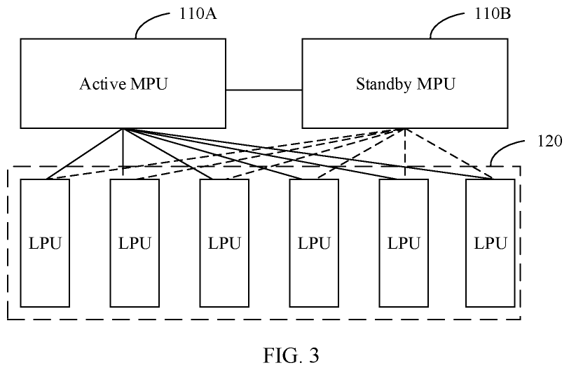

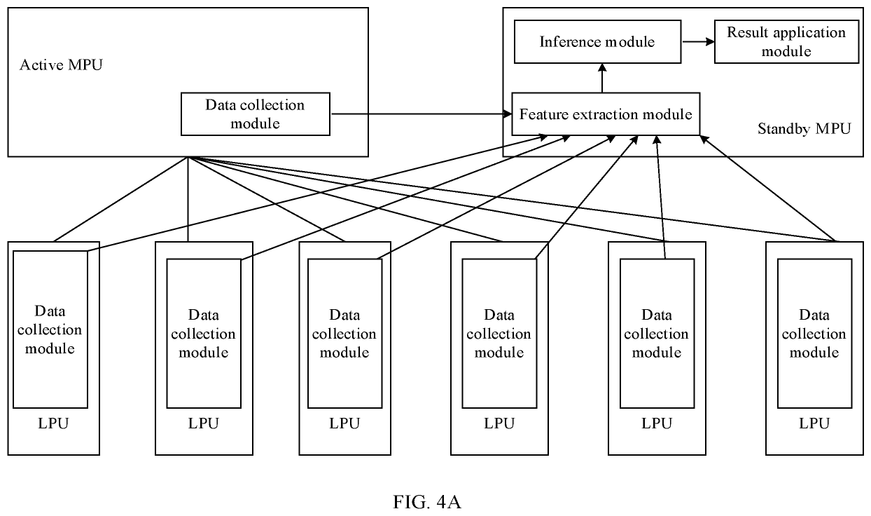

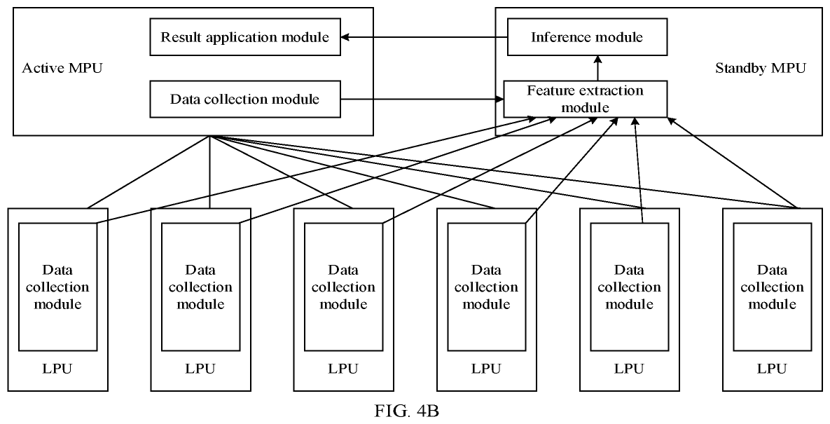

The system 100 may be a network device shown in FIG. 3. The network device includes a plurality of cards, among them, at least two MPUs, n LPUs (n is a natural number), and the like. The MPU is used for system management, control protocol processing, and the like. The LPU is used for distributed packet forwarding, policy execution, and the like, and provides a network interface.

In the network device, the apparatus 110 is an MPU, and works in an active/standby manner. The active apparatus 110A is an active MPU, and the standby apparatus 110B is a standby MPU. The collection apparatus 120 is an LPU.

The network device may be a switch, a router, a broadband remote access server (BRAS), an access controller (AC), or the like.

The network device is typically an embedded device with limited storage and computing resources. In addition, during network device design, only communication requirements such as data packet forwarding and communications protocol packet interaction are considered, and storage and computing resources are not reserved for an added data processing service such as AI.

Each card in the network device has the following characteristics:

An active MPU is configured to run the first service with insufficient computing and storage resources.

A standby MPU is equipped with same resources as an active MPU but usually remains in an idle state.

An LPU can facilitate collection of various types of data.

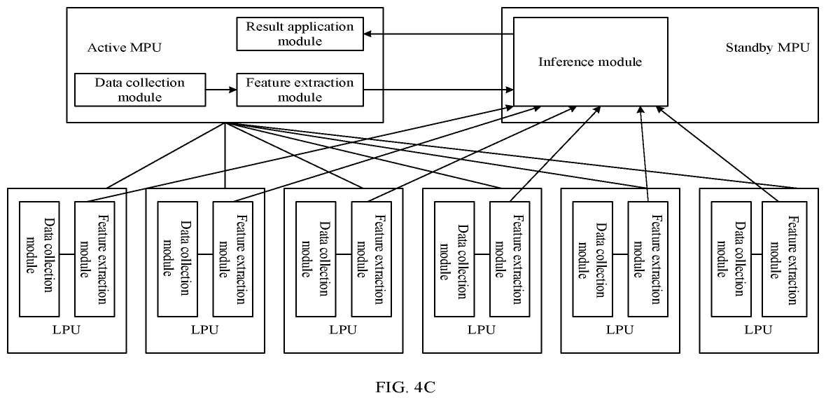

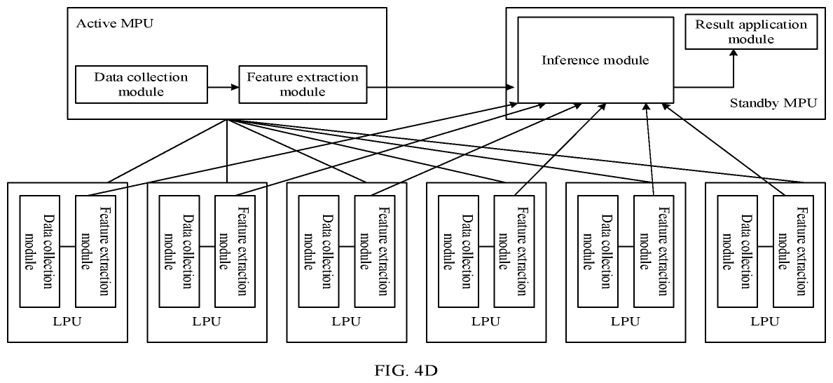

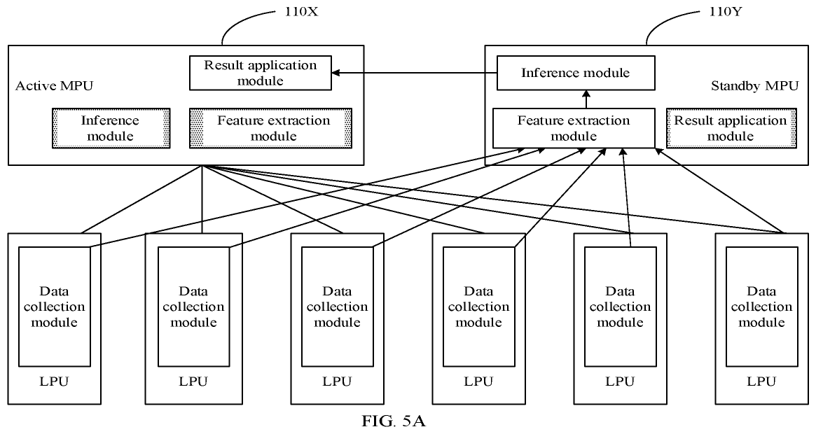

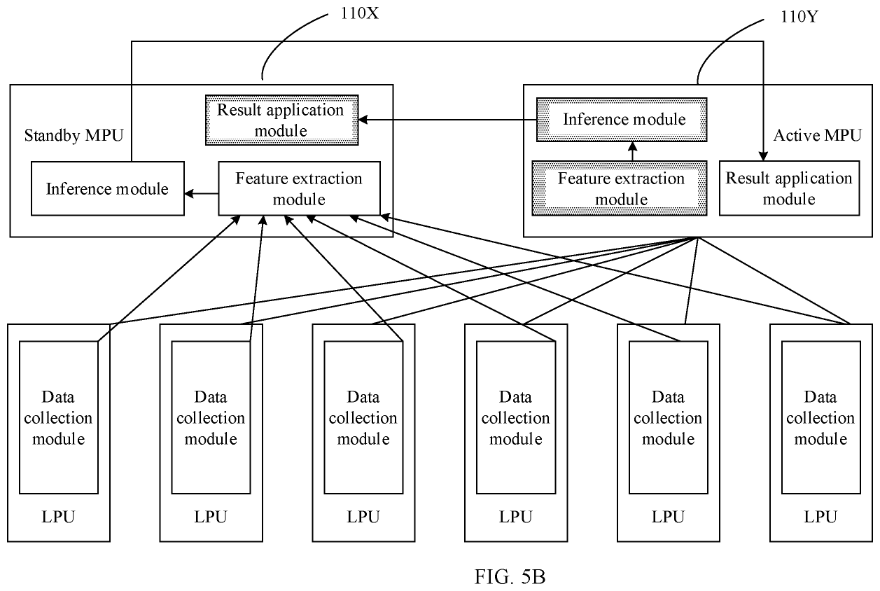

By using an example in which the communications system 100 is the network device shown in FIG. 3 and the second service is an AI service below, deployment manners of function modules for the second service are described with reference to FIG. 4A to FIG. 4D, FIG. 5A, and FIG. 5B.

In each deployment manner, the data collection module is deployed on an apparatus that needs to collect data required by the second service, for example, on an active MPU and/or an LPU. In the deployment manners shown in FIG. 4A to FIG. 4D, it is assumed that both the active MPU and the LPU need to collect data required by the second service. Correspondingly, the data collection module is deployed on both the active MPU and the LPU. In the deployment manners shown in FIG. 5A and FIG. 5B, it is assumed that only the LPU needs to collect data required by the second service. The deployment manners of other function modules are described as follows:

The inference module may be deployed on the standby MPU. Because the inference module occupies a relatively large amount of computing resources, deploying the inference module on the standby MPU can use an idle resource of the standby MPU to ensure execution efficiency of the second service. If the second service further includes a training module independent of the inference module, because the training module also occupies a relatively large amount of computing resources, both the training module and the inference module may be deployed on the standby MPU.

The result application module may be deployed on the active MPU or the standby MPU. If the result application module needs to send the inference result or a processing result obtained by performing further processing based on the inference result to another entity, a location relationship between the other entity and the active MPU or the standby MPU may be considered when a deployment location of the result application module is determined. For example, if the result application module needs to send the inference result or the processing result to another apparatus communicating with the active MPU, or to another module (such as a module processing the first service) on the active MPU, the result application module may be deployed on the active MPU. If the result application module needs to send the inference result or the processing result to another apparatus communicating with the standby MPU, the result application module may be deployed on the standby MPU. In the deployment manners shown in FIG. 4B and FIG. 4C, the result application module is deployed on the active MPU, and in the deployment manners shown in FIG. 4A and FIG. 4D, the result application module is deployed on the standby MPU.

The feature extraction module may be deployed on the standby MPU, to fully use an idle resource of the standby MPU, or may be deployed on an apparatus (such as the active MPU or the LPU) accommodating the data collection module, and the apparatus accommodating the data collection module needs to transmit only the extracted feature data to the standby MPU, without needing to transmit the raw data, thereby greatly reducing a communications bandwidth requirement for communication between the apparatus and the standby MPU.

As shown in FIG. 4A, the feature extraction module, the inference module, and the result application module may be all deployed on the standby MPU. Correspondingly, the apparatuses on which the data collection module is deployed collect the raw data by using the data collection apparatus, and send the raw data to the standby MPU. The standby MPU extracts a feature of the raw data by using the feature extraction module to obtain feature data, draws an inference based on the feature data by using the inference module, and then applies an inference result by using the result application module.

As shown in FIG. 4B, both the feature extraction module and the inference module may be deployed on the standby MPU, and the result application module may be deployed on the active MPU. Correspondingly, the apparatuses on which the data collection module is deployed collect the raw data by using the data collection apparatus, and send the raw data to the standby MPU. The standby MPU extracts a feature of the raw data by using the feature extraction module to obtain feature data, draws an inference based on the feature data by using the inference module, and sends an inference result to the active MPU. The active MPU applies the inference result by using the result application module.

As shown in FIG. 4C, the inference module may be deployed on the standby MPU, the result application module may be deployed on the active MPU, and the feature extraction module may be deployed on the apparatuses (the active MPU and the LPU) accommodating the data collection module. Correspondingly, the apparatuses accommodating the data collection module collect the raw data by using the data collection apparatus, extract a feature of the raw data by using the feature extraction module in the apparatus to obtain feature data, and send the feature data to the standby MPU. The standby MPU draws an inference based on the feature data by using the inference module, and sends an inference result to the active MPU. The active MPU applies the inference result by using the result application module.

As shown in FIG. 4D, both the inference module and the result application module may be deployed on the standby MPU, and the feature extraction module is deployed on the apparatuses (the active MPU and the LPU) accommodating the data collection module. Correspondingly, the apparatuses accommodating the data collection module collect the raw data by using the data collection apparatus, extract a feature of the raw data by using the feature extraction module in the apparatus to obtain feature data, and send the feature data to the standby MPU. The standby MPU draws an inference based on the feature data by using the inference module, and applies an inference result by using the result application module.

In addition, based on the various deployment manners, to improve reliability of the second service, an active/standby deployment manner may be further used for the second service. A function module deployed in the foregoing implementation serves as an active function module. An active function module deployed on the standby MPU is also deployed on the active MPU and serves as a standby function module, and an active function module deployed on the active MPU is also deployed on the standby MPU and serves as a standby function module. When the second service is running, only the active function module is started, and the standby function module is not started. The following describes the active/standby deployment manner of the second service with reference to FIG. 5A and FIG. 5B. In FIG. 5A and FIG. 5B, a colorless function module is an active function module, and a gray function module is a standby function module.

As shown in FIG. 5A and FIG. 5B, the feature extraction module, the inference module, and the result application module are all deployed on the active MPU and the standby MPU. When the second service is running, only the result application module deployed on the active MPU and the feature extraction module and the inference module that are deployed on the standby MPU are started.

As shown in FIG. 5A, an MPU 110X is an active MPU, and an MPU 110Y is a standby MPU. A result application module deployed on the MPU 110X, and a feature extraction module and an inference module that are deployed on the MPU 110Y are started. After the MPUs make an active/standby switch, the MPU 110Y is an active MPU, and the MPU 110X is a standby MPU. As shown in FIG. 5B, a result application module deployed on the MPU 110Y and a feature extraction module and an inference module that are deployed on the MPU 110X are started.

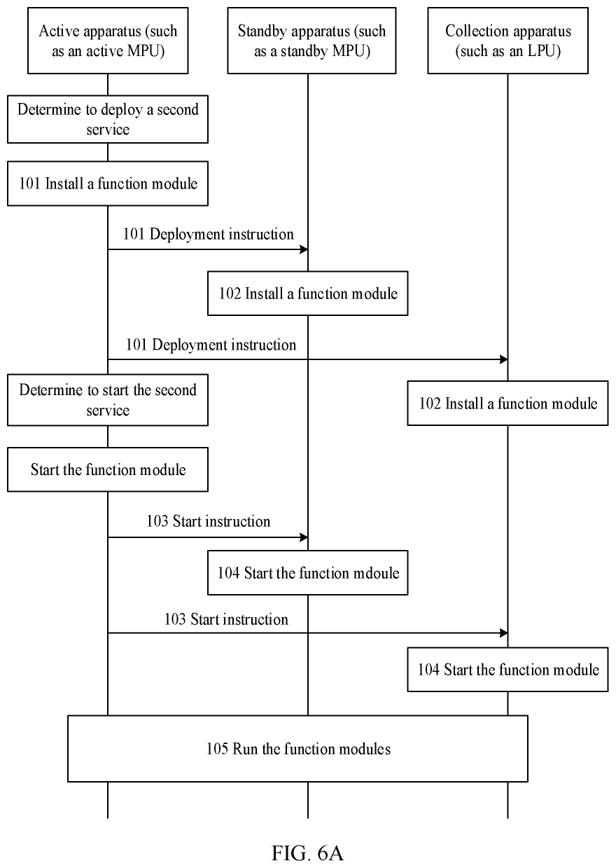

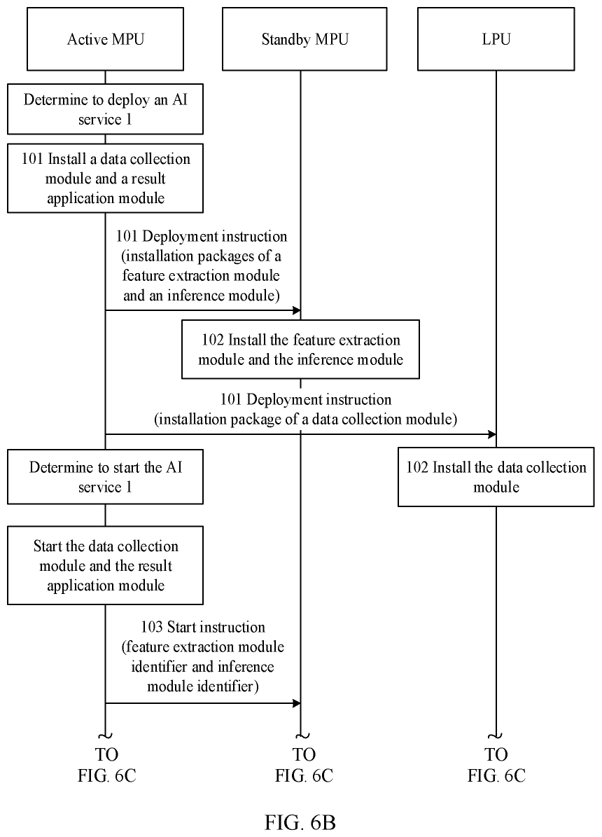

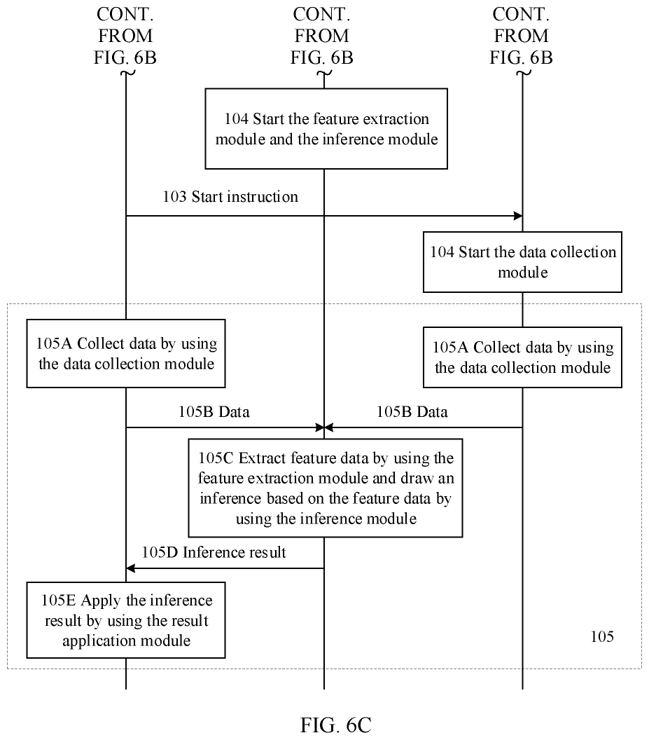

The following describes a method 100 provided in Embodiment 1 of the present disclosure with reference to FIG. 6A, FIG. 6B, and FIG. 6C.

FIG. 6A, FIG. 6B, and FIG. 6C are schematic flowcharts of a method according to Embodiment 1 of the present disclosure. The method according to Embodiment 1 of the present disclosure may be applied to the communications system 100 shown in FIG. 1 or FIG. 3.

S101. When determining to deploy a second service, an active apparatus deploys each function module for the second service.

The active apparatus may perform step S101 when detecting an operation used to instruct to deploy the second service or receiving an instruction used to instruct to deploy the second service. During specific implementation, an administrator may perform an operation by using an operation interface of the active apparatus, to instruct to install an application used to implement the second service, and the active apparatus performs step S101 when detecting the operation.

In step S101, the active apparatus may send a deployment instruction to an apparatus that needs to deploy each function module, to instruct the apparatus to deploy a corresponding function module. The deployment instruction includes an installation package of a to-be-deployed function module. It should be noted that, the apparatus that needs to deploy each function module for the second service includes at least a standby apparatus. For ease of description, function modules deployed on the standby apparatus are collectively referred to as a first function module. The first function module is configured to process data of the second service. The data of the second service may be collected raw data, or may be intermediate data obtained after preliminary processing, for example, feature data. For an AI service, in different deployment manners, the first function module may include only an inference module, or may further include other modules, such as a feature extraction module and a result application module. When only the inference module is included, the data of the second service refers to the feature data. When the feature extraction module is further included, the data of the second service refers to the collected raw data.

If some function modules need to be deployed on the active apparatus, the active apparatus may directly deploy the function modules on the active apparatus, in other words, directly install installation packages of the function modules.

In an implementation, each function module may be deployed, according to a preset correspondence between an identifier of each function module for the second service and an apparatus identifier, on an apparatus identified by a corresponding apparatus identifier.

The following uses an example in which function modules for an AI service 1 and an AI service 2 are deployed on the network device shown in FIG. 3 for description. An MPU and an LPU are data sources of the AI service 1, and an inference result is used for the first service running on an active MPU. An LPU is a data source of the AI service 2, and an inference result needs to be sent to an apparatus outside the communications system.

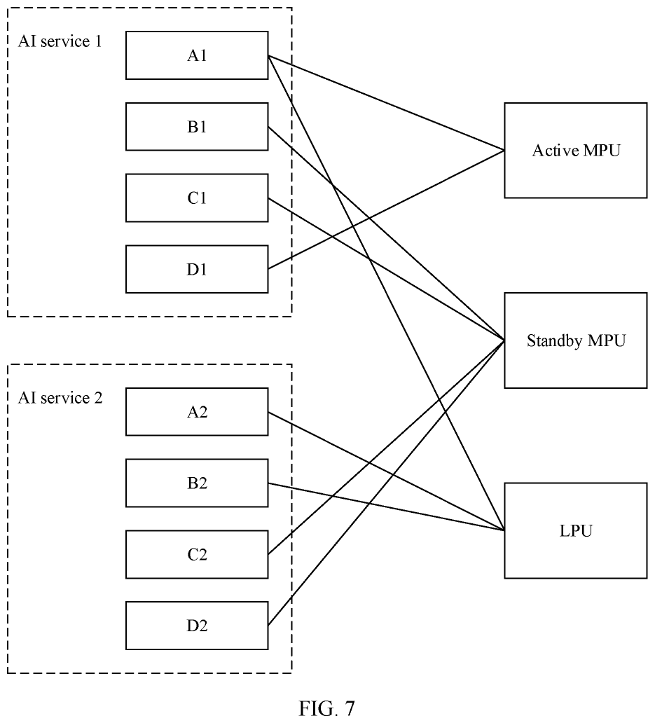

As shown in FIG. 7, the AI service 1 includes a data collection module A1, a feature extraction module B1, an inference module C1, and a result application module D1, and a correspondence shown in Table 1 is established. The AI service 2 includes a data collection module A2, a feature extraction module B2, an inference module C2, and a result application module D2, and a correspondence shown in Table 2 is established.

An identifier of a function module may be a process name of the function module.

TABLE 1

| Identifier of each function | |
|---|---|
| module of the AI service 1 | Apparatus identifier |
| A1 | LPU identifier 1; . . . ; LPU identifier n; |
| | active MPU identifier |
| B1 | Standby MPU identifier |
| C1 | Standby MPU identifier |
| D1 | Active MPU identifier |

TABLE 2

| Identifier of each function | |
|---|---|
| module of the AI service 2 | Apparatus identifier |
| A2 | LPU identifier 1; . . . ; LPU identifier n |
| B2 | LPU identifier 1; . . . ; LPU identifier n |
| C2 | Standby MPU identifier |
| D2 | Standby MPU identifier |

In another implementation, each function module may be deployed, according to a preset correspondence between a function module type and an apparatus identifier, on an apparatus identified by a corresponding apparatus identifier. For example, for each AI service, the data collection module and the feature extraction module are deployed on an apparatus that needs to collect data required by the AI service, and the inference module and the result application module are deployed on a standby MPU.

As shown in FIG. 6B and FIG. 6C, the active MPU determines to deploy the A1 service 1, deploys a data collection module and a result application module locally, and sends a deployment instruction carrying an installation package of a data collection module to each LPU, and a deployment instruction carrying installation packages of a feature extraction module and an inference module to the standby MPU.

It should be noted that, when a plurality of function modules are deployed on a same apparatus, for example, the data collection module and the feature extraction module are deployed on a same apparatus (such as an LPU), or the feature extraction module and the inference module are deployed on a same apparatus (such as a standby MPU), the plurality of function modules may each correspond to one installation package, or may correspond to one overall installation package. In addition, the plurality of function modules may be a plurality of independent function modules, or may be a plurality of submodules of one function module.

S102. An apparatus that receives the deployment instruction deploys a corresponding function module according to the received deployment instruction.

The apparatus installs the corresponding function module based on the installation package in the received deployment instruction.

As shown in FIG. 6B and FIG. 6C, the standby MPU installs the feature extraction module and the inference module according to the received deployment instruction, and the LPU installs the data collection module according to the received deployment instruction.

S103. When determining to start the second service, the active apparatus starts each function module for the second service.

The active apparatus may perform step S103 when detecting an operation used to instruct to run the second service or receiving an instruction used to instruct to run the second service. During specific implementation, an administrator may perform, by using an operation interface of the active apparatus, an operation to start an application for the second service, and the active apparatus performs step S103 when detecting the operation.

In step S103, the active apparatus may send a start instruction to an apparatus that deploys each function module, to instruct the apparatus to start a corresponding function module. The start instruction includes an identifier of a to-be-started function module.

The active apparatus may generate, according to the correspondences shown in Table 1 and Table 2, a start instruction used to start a corresponding function module.

If some function modules are deployed on the active apparatus, the active apparatus directly starts the function modules on the active apparatus.

As shown in FIG. 6B and FIG. 6C, the active MPU starts the data collection module and the result application module that are deployed on the local apparatus, and sends a start instruction carrying a data collection module identifier (A1) to each LPU, and a start instruction carrying a feature extraction module identifier (B1) and an inference module identifier (C1) to the standby MPU.

It should be noted that, as described in step 101, when a plurality of function modules is deployed on the same apparatus, if the plurality of function modules are a plurality of independent function modules, the start instruction for starting the plurality of function modules may include respective identifiers of the plurality of function modules. If the plurality of function modules is a plurality of submodules of one function module (referred to as a function module 1), the start instruction for starting the plurality of function modules may include an identifier of the function module 1.

S104. An apparatus that receives the start instruction starts a corresponding function module according to the received start instruction.

The apparatus starts a corresponding function module according to the identifier of the function module in the received start instruction.

As shown in FIG. 6B and FIG. 6C, the standby MPU starts the feature extraction module and the inference module according to the feature extraction module identifier and the inference module identifier that are carried in the received start instruction, and the LPU starts the data collection module according to the data collection module identifier carried in the received start instruction.

The feature extraction module is configured to extract a feature of the data collected by the data collection module. Therefore, the data collection module is a data producer, and the feature extraction module is a data consumer. In the startup process, the feature extraction module may further subscribe to the data required by the second service. There are two subscription manners: In one manner, a configuration file is used to statically define a data requirement (a condition met by the data required by the second service) between the data producer and the data consumer. In the other manner, the data consumer requests, from the data producer, to obtain data that meets a specified condition through a dynamic application programming interface (API). The subscription operations in both manners may be performed in an initialization phase after the module starts to run.

Correspondingly, the data collection module generates a subscription table that includes the feature extraction module identifier and the condition met by the data required by the second service, and sends the collected data to the corresponding feature extraction module based on information in the subscription table.

It should be noted that different second services may have respective data collection modules for the services, or may share a data collection module. For a manner in which the data collection module is shared, the data collection module needs to separately collect data required by different second services, and therefore, the feature extraction module for each second service usually needs to subscribe to the data required by the service from the data collection module.

S105. Each apparatus runs the started function module to implement the second service.

As shown in FIG. 6B and FIG. 6C, step S105 may include steps S105A to S105E.

S105A and S105B. The active MPU and each LPU collect, by using respectively deployed data collection modules, data required by the second service, and send the collected data to the standby MPU.

S105C and S105D. The standby MPU extracts a feature of the received data by using the feature extraction module to obtain feature data, draws an inference based on the feature data by using the inference module, and sends an inference result to the active MPU.

S105E. The active MPU applies the received inference result by using the result application module.

If the function modules for the second service are deployed in an active/standby deployment manner, when the roles of the active apparatus and the standby apparatus are to be switched, the original active apparatus starts a standby function module deployed on the local apparatus, and the original standby apparatus may synchronize the received data (such as raw data and feature data) to the original active apparatus, and indicate an apparatus (such as an LPU) that sends the data of the second service to the original standby apparatus to send the data to the original active apparatus. If some function modules (such as the result application module) for the second service are also started on the original active apparatus, the original standby apparatus starts corresponding standby function modules on the local apparatus.

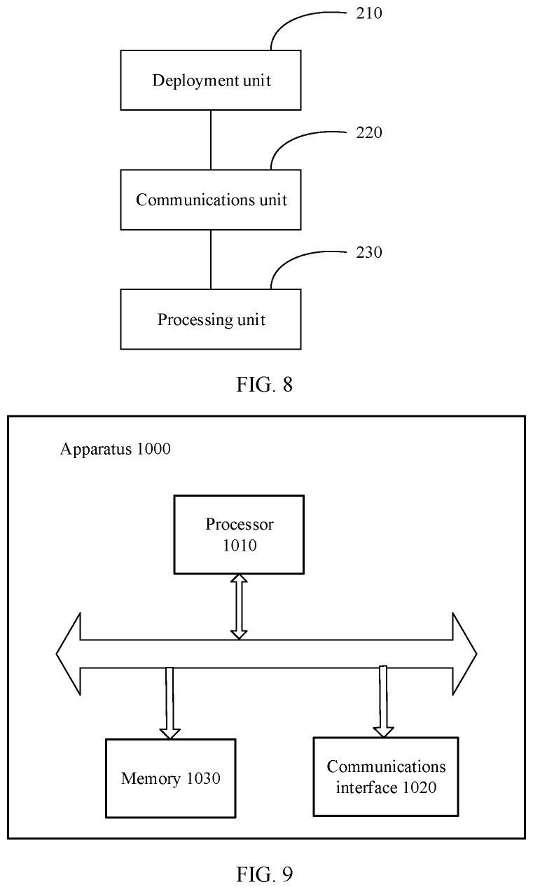

According to Embodiment 1 of the present disclosure, Embodiment 2 of the present disclosure provides an apparatus 200 for implementing service function deployment. As shown in FIG. 8, the apparatus 200 includes a deployment unit 210 and a communications unit 220.

When the apparatus 200 serves as an active apparatus for a first service, the apparatus 200 may further include a processing unit 230. The function units described in Embodiment 2 of the present disclosure may be configured to perform the operations performed by the active apparatus 110A in the method described in Embodiment 1. The communications unit 220 is configured to communicate with another apparatus (such as a standby apparatus for the first service). The processing unit 230 is configured to process the first service. The deployment unit 210 is configured to deploy each function module for a second service by performing step 101, and start each function module by performing step 102. For example, for a function module that needs to be deployed on another apparatus (such as a standby apparatus for the first service), the deployment unit 210 uses the communications unit 220 to send a deployment instruction to the apparatus, to instruct the apparatus to deploy the function module, and uses the communications unit 220 to send a start instruction to the apparatus, to instruct the apparatus to start the function module. In addition, if there is a function module that needs to be deployed on the apparatus 200, the deployment unit 210 is further configured to directly deploy the function module on the apparatus 200, and directly start the function module. A function module (also referred to as a first function module) deployed on the standby apparatus is configured to process data of the second service for the standby apparatus.

When the apparatus 200 serves as a standby apparatus for the first service, the function units described in Embodiment 2 of the present disclosure may be configured to perform the operations performed by the standby apparatus 110B in the method described in Embodiment 1. The communications unit 220 is configured to communicate with another apparatus (such as an active apparatus for the first service). For example, the communications unit 220 is configured to receive a deployment instruction and a start instruction that are sent by the active apparatus for the first service. The deployment instruction is used to instruct the standby apparatus to deploy some or all of function modules (also referred to as a first function module) for a second service. The start instruction is used to instruct to start the first function module. The deployment unit 210 is configured to deploy the first function module according to the deployment instruction, and start the first function module according to the start instruction. The first function module is configured to process data of the second service.

According to Embodiment 1 of the present disclosure, Embodiment 3 of the present disclosure provides an apparatus 1000 for implementing service function deployment. The apparatus 1000 may be an MPU. As shown in FIG. 9, the apparatus 1000 includes a processor 1010 and a communications interface 1020, and may further include a memory 1030. The processor 1010, the communications interface 1020, and the memory 1030 may communicate with each other by using a bus.

The processor 1010 may be a CPU or an application-specific integrated circuit (ASIC), or may be configured as one or more integrated circuits that implement this embodiment of the present disclosure.

The memory 1030 may be a high-speed random-access memory (RAM), or may be a non-volatile memory.

When the apparatus 1000 serves as an active apparatus (such as an active MPU) for a first service, the processor 1010 is configured to perform the operations performed by the active apparatus 110A in the method described in Embodiment 1. The operations may be performed by executing computer operation instructions stored in the memory 1030. The communications interface 1020 is configured to communicate with another apparatus (such as a standby apparatus for the first service).

When the apparatus 1000 serves as a standby apparatus (such as a standby MPU) for the first service, the processor 1010 is configured to perform the operations performed by the standby apparatus 110B in the method described in Embodiment 1. The operations may be performed by executing computer operation instructions stored in the memory 1030. The communications interface 1020 is configured to communicate with another apparatus (such as an active apparatus for the first service).

1. A system for implementing service function deployment, comprising:
an active apparatus for a first service, wherein the active apparatus is configured to:
process the first service; and
deploy a first function module for a second service on a standby apparatus, wherein the second service is an artificial intelligence (AI) service; and
the standby apparatus configured to process data of the second service by using the first function module.

2. The system of claim 1, wherein the first function module comprises an inference module, and wherein the standby apparatus is further configured to draw, based on feature data of the second service by using the inference module, an inference to obtain an inference result.

3. The system of claim 2, wherein the first function module further comprises a feature extraction module, and wherein the standby apparatus is further configured to extract, by using the feature extraction module, a feature of raw data of the second service to obtain the feature data.

4. The system of claim 2, wherein the active apparatus is further configured to:
deploy a feature extraction module for the second service on the active apparatus;
extract, by using the feature extraction module, a feature of raw data of the second service to obtain the feature data; and
send the feature data to the standby apparatus,
wherein the standby apparatus is further configured to receive the feature data from the active apparatus.

5. The system of claim 4, wherein the active apparatus is further configured to deploy a data collection module for the second service on the active apparatus, and wherein the active apparatus is further configured to collect, by using the data collection module, the raw data of the second service.

6. The system of claim 2, wherein the active apparatus is further configured to deploy a result application module for the second service on the active apparatus, wherein the standby apparatus is further configured to send the inference result to the active apparatus, and wherein the active apparatus is further configured to:
receive the inference result from the standby apparatus; and
apply, by using the result application module, the inference result.

7. The system of claim 2, wherein the first function module further comprises a result application module, and wherein the standby apparatus is further configured to apply, by using the result application module, the inference result.

8. The system of claim 1, wherein the system is a network device, wherein the network device comprises a plurality of main processing units (MPUs), wherein the active apparatus is an active MPU, and wherein the standby apparatus is a standby MPU.

9. The system of claim 2, wherein the system is a network device, wherein the network device comprises a plurality of main processing units (MPUs), wherein the active apparatus is an active MPU, wherein the standby apparatus is a standby MPU, wherein the network device further comprises a line processing unit (LPU), wherein the active MPU is further configured to deploy a data collection module for the second service and a feature extraction module for the second service on the LPU, and wherein the LPU is configured to:
collect, by using the data collection module, data of the second service;
extract, by using the feature extraction module, a feature of the data to obtain the feature data; and
send the feature data to the standby MPU.

10. The system of claim 1, wherein the second service has a plurality of function modules, and wherein the active apparatus is further configured to:
deploy, according to a first preset correspondence between an identifier of each function module for the second service and a first apparatus identifier, each function module on a first apparatus identified by a corresponding apparatus identifier; or
deploy, according to a second preset correspondence between a function module type and a second apparatus identifier, each function module on a second apparatus identified by the second apparatus identifier corresponding to the function module type to which the function module belongs.

11. The system of claim 1, wherein the active apparatus is further configured to:
determine to start the second service; and
send, when determining to start the second service, a start instruction comprising each function module for the second service to an apparatus accommodating the function module,
wherein the start instruction instructs to start the function module.

12. A method for implementing service function deployment, wherein the method is performed by an active apparatus for a first service, and wherein the method comprises:
processing the first service; and
deploying a first function module for a second service on a standby apparatus for the first service,
wherein the first function module is configured to process data of the second service, and
wherein the second service is an artificial intelligence (AI) service.

13. The method of claim 12, wherein the first function module comprises an inference module, and wherein the method further comprises drawing, based on feature data of the second service by the inference module, an inference to obtain an inference result.

14. The method of claim 13, wherein the first function module further comprises a feature extraction module, and wherein the method further comprises extracting, by using the feature extraction module, a feature of raw data of the second service to obtain the feature data.

15. The method of claim 13, further comprising:
deploying a feature extraction module for the second service on the active apparatus;
extracting, by using the feature extraction module to obtain the feature data, a feature of raw data of the second service; and
sending the feature data to the standby apparatus.

16. The method of claim 13, wherein the active apparatus is an active main processing unit (MPU) in a network device, wherein the standby apparatus is a standby MPU in the network device, wherein the and the network device further comprises a line processing unit (LPU), and wherein the method further comprises:
deploying a data collection module for the second service and a feature extraction module for the second service on the LPU;
collecting, by the data collection module, data of the second service; and
extracting, by using the feature extraction module, a feature of the data to obtain the feature data.

17. A method for implementing service function deployment, wherein the method is performed by a standby apparatus for a first service, and wherein the method comprises:
receiving a deployment instruction from an active apparatus for the first service, wherein the deployment instruction instructs the standby apparatus to deploy a first function module for a second service, and wherein the second service is an artificial intelligence (AI) service;
deploying the first function module according to the deployment instruction; and
processing, by using the first function module, data of the second service.

18. The method of claim 17, wherein the first function module comprises an inference module, and wherein the method further comprises drawing, based on feature data of the second service by using the inference module, an inference.

19. The method of claim 18, wherein the first function module further comprises a feature extraction module, and wherein the method further comprises:
extracting, by using the feature extraction module, a feature of raw data of the second service to obtain the feature data;
drawing, based on the feature data by using the feature extraction module, the inference.

20. The method of claim 17, wherein the active apparatus is an active MPU in a network device, and wherein the standby apparatus is a standby MPU in the network device.
